(19) United States
(12) Patent Application Publication
(10) Pub. No.: US 2026/0180052 A1
(43) Pub. Date: Jun. 25, 2026

(54) BATTERY CAMERA, LOW-POWER MODE CONTROL METHOD THEREOF, AND COMPUTER-READABLE STORAGE MEDIUM

(71) Applicant: Shenzhen Reolink Technology Co., Ltd., Shenzhen (CN)

(72) Inventors: Guodong Xu, Shenzhen (CN); Peiyong Yao, Shenzhen (CN); Han Yang, Shenzhen (CN); Zhitao Yuan, Shenzhen (CN); Chaohui Lin, Shenzhen (CN); Xingyu Peng, Shenzhen (CN); Jiuming Li, Shenzhen (CN)

(21) Appl. No.: 19/535,186

(22) Filed: Feb. 10, 2026

(30) Foreign Application Priority Data
Feb. 13, 2025 (CN) 202510161818.X

(51) Int. Cl. H01M 10/48; H04N 23/65

(52) U.S. Cl. CPC H01M 10/48; H04N 23/651

(57) ABSTRACT

The present application relates to the technical field of security video surveillance, and discloses a battery camera, a low-power mode control method thereof, and a computer-readable storage medium. The method comprises: acquiring a battery level of the battery camera, in a case where the battery camera is operating in a continuous recording mode under a normal-power mode; comparing the battery level with a first battery level threshold; entering an alarm wake-up recording mode from the continuous recording mode, in a case where the battery level is lower than or equal to the first battery level threshold. As such, the battery camera can operate with reduced power consumption, thereby extending its battery life.

### TECHNICAL FIELD

The embodiments of the present application relate to the technical field of security video surveillance, and specifically, to a battery camera, a low-power mode control method thereof, and a computer-readable storage medium.

### BACKGROUND

A battery camera is a portable surveillance device. Compared to cameras powered by a fixed power supply, a battery camera relies on a built-in rechargeable battery for power, thus it can operate independently without an external power supply, making it suitable for flexible deployment and mobile surveillance.

In the related art, a battery camera is in a standby state most of the time instead of performing continuous recording. It only wakes up to operate when an alarm is triggered or a network connection is established. Moreover, a pre-recorded video of a fixed duration is only available if an alarm is triggered while the battery camera is operating. Continuous recording refers to continuously reading a video stream from memory to generate recording files during the camera's operation. Typically, DC-powered cameras can support continuous recording. Since a battery camera does not operate continuously for long periods, and the proportion of active time triggered by services is very small compared to the standby time, operating in a low-power mode during active periods is generally not considered. However, the aforementioned operating mode of the battery camera also has some problems. Due to battery level limitations, most battery cameras do not perform continuous recording. Mostly they start recording when an alarm is triggered from the standby state. Thus, most battery cameras lack pre-recording videos, which prevents users from reviewing the footage before the alarm. Furthermore, if an alarm is missed, critical footage may not be recorded, and users cannot review recordings of key moments of interest.

However, if a battery camera is to implement a pre-recording function or a continuous recording function, the encoding chip of the battery camera needs to run continuously. In this case, how to reduce the power consumption of the battery camera as much as possible to extend its battery level is a problem that needs to be solved.

### SUMMARY

In view of the above problems, embodiments of the present application provide a battery camera, a low-power mode control method thereof, and a computer-readable storage medium, which aim to reduce the power consumption of a battery camera when operating in a pre-recording mode or a scheduled recording mode.

According to one aspect of an embodiment of the present application, a low-power mode control method for a battery camera is provided, the method comprising: determining whether the battery camera needs to enter a low-power mode; if the battery camera needs to enter the low-power mode, determining whether a current operating mode of the battery camera is a pre-recording mode or a scheduled recording mode; if the current operating mode is the pre-recording mode, reducing a recording frame rate of the battery camera; if the current operating mode is the scheduled recording mode, determining whether to reduce the recording frame rate based on a current battery level of the battery camera; if the current battery level is within a pre-set battery level threshold range, reducing the recording frame rate of the battery camera; and controlling the battery camera to operate in the low-power mode.

If the current operating mode is the scheduled recording mode, and a smart power-saving mode of the battery camera is enabled, the method further comprises: when the current battery level is lower than or equal to a first battery level threshold, controlling the battery camera to exit the scheduled recording mode and enter a standby alarm wakeup state; when the current battery level is between the first battery level threshold and a second battery level threshold, controlling the battery camera to record at the reduced recording frame rate; and when the current battery level is greater than the second battery level threshold, controlling the battery camera to record at a pre-set full frame rate, wherein the second battery level threshold is greater than the first battery level threshold.

If the current operating mode of the battery camera is the scheduled recording mode, and the smart power-saving mode of the battery camera is disabled, the method further comprises: when the current battery level is lower than or equal to a pre-set cut-off recording battery level, controlling the battery camera to exit the scheduled recording mode and enter the standby alarm wakeup state; and when the current battery level is greater than the pre-set cut-off recording battery level, controlling the battery camera to operate in the scheduled recording mode and record at the pre-set full frame rate.

The battery camera is determined to enter the low-power mode when one or more of the following conditions are met: a network of the battery camera is disabled, no alarm event exists for the battery camera, the battery camera is not acquiring results of an Artificial Intelligence (AI) model detection, and the battery camera has no connection request from an external device.

Alternatively, the method further comprises: wherein the battery camera needs to enter the low-power mode, stopping an AI model detection function of the battery camera.

Alternatively, the method further comprises: wherein the battery camera is operating in the pre-recording mode or the scheduled recording mode and is in the low-power mode, in response to detecting an alarm event or receiving a connection request from an external device, restoring the AI model detection function of the battery camera and controlling the battery camera to exit the low-power mode.

Alternatively, the method further comprises: after the battery camera has been powered on for a pre-set duration, determining whether the battery camera requires network services; and wherein the battery camera does not require the network services, disabling the network of the battery camera, turning off peer-to-peer (P2P) listening of the battery camera, and de-initializing a P2P function of the battery camera.

Alternatively, the method further comprises: wherein the network of the battery camera is disabled, an encoding chip of the battery camera sending a sleep identifier bit to a micro-controller unit of the battery camera; and in response to receiving the sleep identifier bit, the micro-controller unit disconnecting communication with the encoding chip and entering a sleep mode.

Alternatively, the method further comprises: wherein the network of the battery camera is disabled, the encoding chip setting a first flag to cause the battery camera to be in the low-power mode.

Alternatively, the method further comprises: reducing a hardware operating frequency of the battery camera, wherein the hardware operating frequency is an operating frequency of frequency-adjustable hardware of the battery camera, and the frequency-adjustable hardware comprises one or more of a micro-controller, a memory, an encoding chip, an image acquisition unit, and an image signal processor.

Alternatively, the method further comprises: wherein the battery camera is operating in the pre-recording mode or the scheduled recording mode and is in the low-power mode, in response to detecting an alarm event or receiving a connection request from an external device, performing the following operations: restoring the hardware operating frequency of the battery camera to an operating frequency prior to entering the low-power mode; restoring the recording frame rate to a recording frame rate prior to entering the low-power mode; and controlling the battery camera to exit the low-power mode.

Alternatively, the method further comprises: when the battery camera is operating in the pre-recording mode or the scheduled recording mode and is in the low-power mode, in response to establishment of a network connection, enabling the network of the battery camera, initializing the peer-to-peer (P2P) function of the battery camera, turning on the P2P listening of the battery camera, and restoring communication between the micro-controller and the encoding chip of the battery camera.

When the battery camera is operating in the pre-recording mode, video of a monitored area is captured during a pre-set pre-recording schedule time and encoded to obtain a video stream, and a video stream of a latest pre-set duration is dynamically stored to a memory of the battery camera to generate a pre-recorded video when an alarm is triggered; when the battery camera is operating in the scheduled recording mode, video of the monitored area is captured during a pre-set scheduled recording time and encoded to obtain the video stream, and video transcoding is performed on the video stream to obtain a recorded video.

According to another aspect of an embodiment of the present application, a battery camera is provided, comprising: a memory and at least one processor; the memory stores computer-executable instructions; the at least one processor executes the computer-executable instructions stored in the memory, causing the at least one processor to perform the low-power mode control method for a battery camera as described above.

According to yet another aspect of an embodiment of the present application, a computer-readable storage medium is provided, wherein the storage medium stores executable instructions, and the executable instructions, when run, perform the low-power mode control method for a battery camera as described above.

Embodiments of the present application enable a battery camera to operate in a pre-recording mode or a scheduled recording mode while reducing power consumption and extending battery life by determining whether the battery camera meets conditions for entering a low-power mode, and if so, reducing the recording frame rate to cause the battery camera to enter the low-power mode.

The foregoing description is only an overview of the technical solutions of the embodiments of the present application. To make the foregoing and other objects, features, and advantages of the embodiments of the present application more apparent, specific embodiments of the present application are described in detail below in accordance with the content of the specification.

### BRIEF DESCRIPTION OF THE DRAWINGS

The accompanying drawings are for illustrative purposes of the embodiments only and are not to be construed as a limitation on the present application. Moreover, throughout the drawings, the same reference numerals denote the same components. In the drawings:

FIG. 1 is a schematic diagram of an application scenario of a low-power mode control method for a battery camera provided by an embodiment of the present application;

FIG. 2 is a schematic structural block diagram of a battery camera provided by an embodiment of the present application;

FIG. 3A is a schematic flowchart of a control method for a battery camera entering a low-power mode provided by an embodiment of the present application;

FIG. 3B is a schematic flowchart of a control method for a battery camera exiting a low-power mode provided by an embodiment of the present application;

FIG. 4 is a detailed schematic flowchart of a control method for a battery camera entering a low-power mode provided by an embodiment of the present application;

FIG. 5 is a detailed schematic flowchart of a control method for a battery camera exiting a low-power mode provided by an embodiment of the present application.

### DETAILED DESCRIPTION

Exemplary embodiments of the present application will be described in more detail below with reference to the accompanying drawings. Although exemplary embodiments of the present application are shown in the drawings, it should be understood that the present application may be implemented in various forms and should not be limited by the embodiments set forth herein.

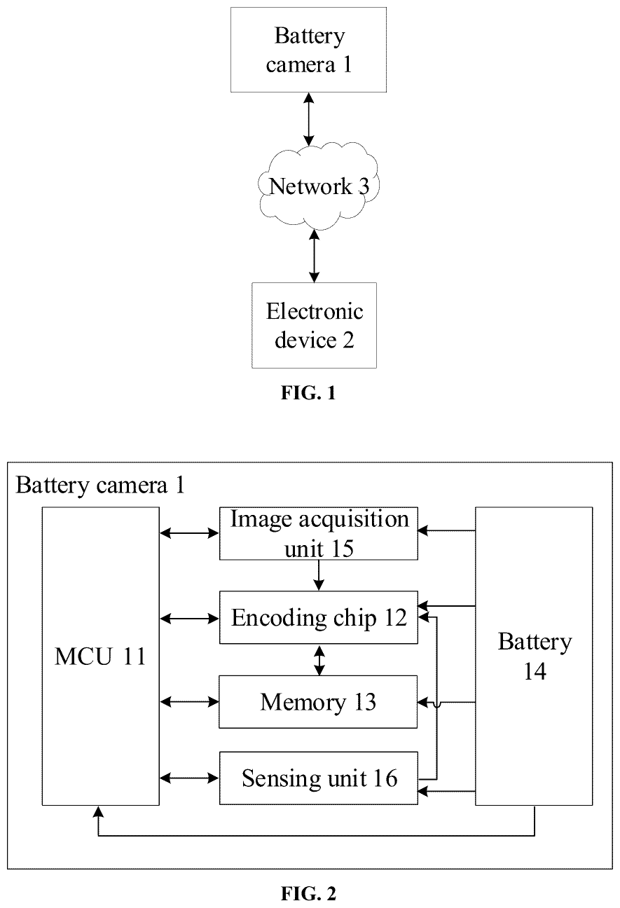

FIG. 1 is a schematic diagram of an application scenario of a low-power mode control method for a battery camera provided by an embodiment of the present application. In this embodiment, the low-power mode control method is applied in a battery camera 1. The battery camera 1 establishes a communication connection with an electronic device 2 via a network 3. The battery camera 1 can be a camera powered by a battery for security surveillance, a network camera, or other video surveillance equipment. The electronic device 2 can be a touch-screen mobile phone, a smartphone, a tablet computer, a portable electronic device, or other electronic device with a display screen, and is also commonly referred to as a client. The network 3 comprises, but is not limited to, one or more of a Local Area Network (LAN), a Metropolitan Area Network (MAN), a Wide Area Network (WAN), a 4G/5G network, Wi-Fi, Bluetooth, and a peer-to-peer (P2P) communication network.

In an embodiment of the present application, both the battery camera 1 and the electronic device 2 can comprise one or more processors. The processor may be a Micro-Controller Unit (MCU), a Central Processing Unit (CPU), an Application-Specific Integrated Circuit (ASIC), or one or more integrated circuits configured to implement this embodiment, which is not limited herein. The one or more processors comprised in the electronic device can be of the same type, such as one or more CPUs, or of different types, such as one or more CPUs and one or more ASICs, which is not limited herein.

At least one processor of the battery camera 1 is configured to execute computer-executable instructions, causing the at least one processor to perform the operations of the low-power mode control method for a battery camera.

In an embodiment of the present application, the battery camera 1 is installed in a monitored area (e.g., a home, office, shopping mall, etc.), so that the battery camera 1 can capture surveillance video within the monitored area and send the captured video to the electronic device 2 via the network 3 for a user to browse.

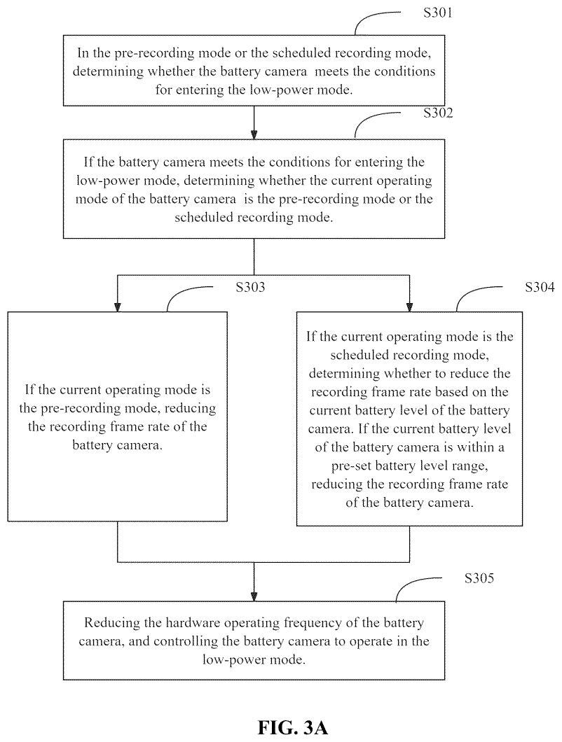

FIG. 2 is a schematic structural diagram of a battery camera provided by an embodiment of the present application. As shown in FIG. 2, the battery camera 1 can comprise an MCU 11, an encoding chip 12, a memory 13, a battery 14, an image acquisition unit 15, and a sensing unit 16.

The MCU 11 is configured to execute computer programs, and specifically can execute the relevant steps in the embodiments of the low-power mode control method for a battery camera provided by the present application. The computer programs can comprise computer-executable instructions. The MCU's power consumption is low, which extends battery life. The highly integrated design of the MCU reduces the need for external components, lowering the cost and size of the battery camera 1. Moreover, the processing capability of the MCU can meet the embedded surveillance needs of the battery camera 1. In other embodiments, other control units such as a CPU or an ASIC can also be used to implement the functions of the MCU 11.

The image acquisition unit 15 is composed of an image sensor (such as a CMOS or CCD sensor) and related signal processing circuits, and is configured to capture video images of the monitored area by capturing light from the environment of the monitored area and converting it into video electrical signals.

The encoding chip 12 is configured to execute computer programs, and specifically can execute the relevant steps in the embodiments of the low-power mode control method for a battery camera provided by the present application. The main function of the encoding chip 12 is to convert the video electrical signals captured by the image acquisition unit 15 into digital video signals and perform compression encoding to obtain a video stream, so as to reduce the amount of video data for easy transmission over a network.

The memory 13 is configured to store the video stream. The memory 13 may comprise high-speed Random Access Memory (RAM), and may also comprise non-volatile memory, such as at least one disk storage device. The RAM can be Double Data Rate Synchronous Dynamic Random-Access Memory (DDR SDRAM, or DDR for short).

The battery 14 provides electrical energy to various power-consuming components in the battery camera 1 (e.g., the MCU 11, the encoding chip 12, the memory 13, the image acquisition unit 15, and the sensing unit 16). The battery 14 can be a rechargeable lithium-ion battery or a lithium-polymer battery.

The sensing unit 16 is configured to detect targets within the monitored area, such as vehicles, people, or animals. Examples comprise a Passive Infrared (PIR) sensor, a Motion Detection (MD) module, a human shape detection module, etc. Taking a PIR sensor as an example, if a human body enters the monitored area, the sensing unit 16 can sense the infrared heat source radiated by the human body.

The battery camera 1 can also comprise other units, such as a communication unit for wirelessly transmitting data to an external device or a cloud server via the network 3, and a microphone for capturing voice input, which are not exhaustively listed herein.

In an embodiment of the present application, the battery camera 1 is pre-configured with a pre-recording mode. Both the MCU 11 and the encoding chip 12 store parameters related to the pre-recording mode, such as a pre-recording mode switch parameter, a stop pre-recording battery level, a recording frame rate, a pre-recording schedule time, and a pre-recording duration. After the battery camera 1 is powered on and started, if the switch for the pre-recording mode is enabled, the MCU 11 determines whether conditions for entering the pre-recording mode are met based on the current state of the battery camera 1, for example, whether the current battery level of the battery camera 1 is greater than or equal to the stop pre-recording battery level, and whether the current time of the battery camera 1 is within the pre-recording schedule time. If the conditions are met, the pre-recording mode is entered. In the pre-recording mode, the image acquisition unit 15 captures video of a monitored area and encodes the video to generate a video stream, and the video stream is temporarily stored in a rolling manner in the memory 13. When an alarm is triggered by the sensing unit 16 in response to an intruding target in the monitored area, the encoding chip 12 is configured to retrieve, from the temporarily stored video stream, the video stream corresponding to the pre-recording duration preceding the alarm time to generate a pre-recorded video. A user can view the pre-recorded video through a playback function, an FTP service, and a cloud service in an application (APP) installed on the electronic device 2 to understand the situation in the monitored area for a period before the alarm was triggered. In this way, the battery camera 1 is enabled to operate in the pre-recording mode when pre-set conditions are met. In the pre-recording mode, the video surveillance footage within the pre-recording duration before each alarm trigger can be traced back, thereby allowing the user to better understand the alarm situation and learn about the behavior of the intruding target in the monitored area before the alarm was triggered.

In an embodiment of the present application, the battery camera 1 is also pre-configured with a scheduled recording mode. Both the MCU 11 and the encoding chip 12 store parameters related to the scheduled recording mode, such as a battery level for stopping scheduled recording and a scheduled recording time. The MCU 11 controls the start and end of the scheduled recording mode, and the encoding chip 12 performs the scheduled recording. After the battery camera 1 is powered on and started, the MCU 11 determines whether conditions for entering the scheduled recording mode are met based on the current state of the battery camera 1, for example, whether the current time of the battery camera 1 is within the scheduled recording time, and whether the current battery level of the battery camera 1 is greater than the battery level for stopping scheduled recording. If the conditions are met, the scheduled recording mode is entered. In the scheduled recording mode, the image acquisition unit 15 captures video of the monitored area and encodes it to generate a video stream, the video stream is temporarily stored in a rolling manner in the memory 13, and the encoding chip 12 performs video transcoding on the temporarily stored video stream to obtain a recorded video. A user can view the scheduled recording video through the playback function, FTP service, and cloud service in the APP installed on the electronic device 2 to understand the situation in the monitored area during the scheduled recording time. In this way, the battery camera 1 is enabled to operate in the scheduled recording mode when pre-set conditions are met. In the scheduled recording mode, continuous recording can be performed according to the scheduled recording time configured by the user without an alarm being triggered, thereby avoiding the inability to review the surveillance footage at the time of an incident in case of false or missed alarms, which can occur with methods that only record upon an alarm trigger.

In an embodiment of the present application, the battery camera 1 is configured to operate in the pre-recording mode when the current time is within the pre-recording schedule time and the current battery level is greater than the stop pre-recording battery level. In the pre-recording mode, the video surveillance footage within the pre-recording duration before each alarm trigger can be traced back, thereby allowing the user to better understand the alarm situation and learn about the behavior of the intruding target in the monitored area before the alarm was triggered. The battery camera 1 is configured to operate in the scheduled recording mode when the current time is within the scheduled recording time and the current battery level is greater than or equal to the battery level for stopping scheduled recording, achieving continuous recording according to the scheduled recording time configured by the user without an alarm being triggered. The user can view the recording at any time within the scheduled recording time on a playback interface.

After the battery camera 1 enters the pre-recording mode, the encoding chip 12 of the battery camera 1 runs continuously. When an alarm is triggered, the encoding chip 12 searches the memory 13 for the video stream from a duration of about 2 to 10 s (configurable by the user through an interactive interface of a client APP, such as on a mobile phone) preceding the alarm time to generate a pre-recorded video. The pre-recorded video can serve as the beginning of a recording file generated after an alarm is triggered. The user can view the recording file via playback, cloud storage, and FTP services to understand the situation in the monitored area for a period before the alarm was triggered. After the battery camera 1 enters the scheduled recording mode, the encoding chip 12 also runs continuously, constantly reading the video stream from the memory 13 to generate recording files, so as to achieve continuous recording within the scheduled recording time specified by the user.

In an embodiment of the present application, when the battery camera 1 is operating in the pre-recording mode or the scheduled recording mode, the battery camera 1 is configured to run in a low-power mode to reduce the power consumption of the battery camera 1 and increase the battery level of the battery camera 1.

The electronic device 2 can provide a pre-recording mode configuration interface and a scheduled recording mode configuration interface for the user to configure related parameters for the pre-recording mode and the scheduled recording mode, respectively, through said interfaces. The electronic device 2 obtains the parameters configured by the user and sends the configured parameters to the battery camera 1 via the network 3.

After the battery camera 1 receives the parameters configured by the user, the encoding chip 12 of the battery camera 1 stores the aforementioned parameters. For example, the encoding chip 12 can store the aforementioned parameters in a parameter partition of its flash memory. The encoding chip 12 also transmits some of the aforementioned parameters (for example, parameters used to determine whether the conditions for entering the pre-recording mode are met and parameters used to determine whether the conditions for entering the scheduled recording mode are met) to the MCU 11 for storage and subsequent use by the MCU 11.

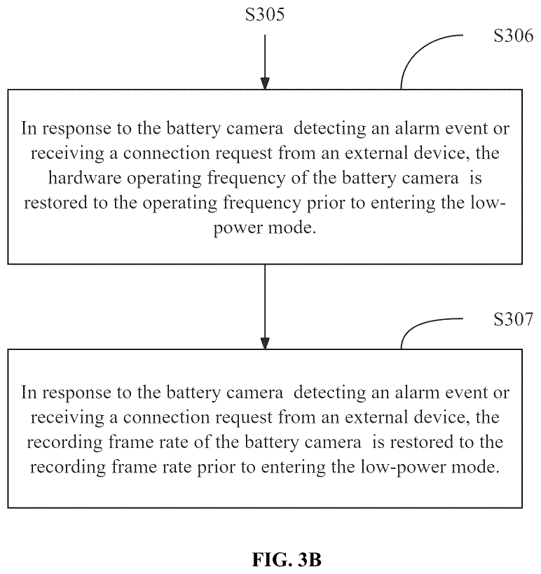

FIG. 3A shows a schematic flowchart of a method for controlling a battery camera to enter a low-power mode, according to an embodiment of the present application. The method is applied in the battery camera 1. As shown in FIG. 3A, the method comprises the following steps:

S301, in the pre-recording mode or the scheduled recording mode, determining whether the battery camera 1 meets the conditions for entering the low-power mode.

When the battery camera 1 operates in the pre-recording mode, video of the monitored area is captured during a pre-recording schedule time and encoded to generate a video stream, and the video stream within a most recent pre-set duration (e.g., 10 seconds, 15 seconds, or 20 seconds) is dynamically stored in the memory 13 of the battery camera 1 so that a pre-recorded video can be generated when an alarm is triggered. When the battery camera 1 operates in the scheduled recording mode, video of the monitored area is captured during a scheduled recording time and encoded to generate a video stream, and video transcoding is performed on the video stream to obtain a recorded video.

The conditions for the battery camera 1 to enter the low-power mode comprise one or more of the following: a network of the encoding chip 12 is disabled, no alarm event exists, acquisition of Artificial Intelligence (AI) model detection results is not being performed, and there is no connection request from an external device. This embodiment of the present application is described using an example where the conditions for entering the low-power mode comprise all of the above conditions, that is, if the network of the encoding chip 12 is disabled, no alarm event exists, acquisition of AI model detection results is not being performed, and there is no connection request from an external device, then the conditions for entering the low-power mode are considered met.

Wherein, after the battery camera 1 has been powered on for a pre-set duration, it is determined whether the battery camera 1 currently requires network services. If the battery camera 1 does not currently require network services, the network of the encoding chip 12 is disabled, the Point-to-Point (P2P) listening of the battery camera 1 is turned off, and the P2P function of the battery camera 1 is de-initialized. The P2P function is a convenient point-to-point communication technology that allows a user to directly connect to the battery camera 1 via the Internet without complex network configurations, such as port mapping or dynamic DNS settings, thereby simplifying the device installation and access process and enabling the user to easily use the electronic device 2, such as a smartphone or computer, to monitor and receive video streams from the battery camera 1 in real time from any location. Disabling the network of the encoding chip 12, turning off the P2P listening of the battery camera 1, and de-initializing the P2P function of the battery camera 1 can all reduce the power consumption of the battery camera 1.

Regarding disabling the network of the encoding chip 12, specifically, each network service has a unique network identifier bit (e.g., a busy bit). After a pre-set duration (e.g., 15 s) from power-on and waking up the encoding chip 12, an MCU process of the encoding chip 12 determines whether the network is needed based on the network identifier bit of each network service. For example, if the busy bit is “1”, it indicates that the network is needed, and if the busy bit is “0”, it indicates that the network is not needed. If the network is needed, no processing is performed. If the network is not needed, the network of the encoding chip 12 is disabled, P2P listening is turned off, and the P2P function is de-initialized.

Through the above method, when the battery camera 1 does not require network services after being powered on, the network of the encoding chip 12 is in a disabled state. When the battery camera 1 meets the other conditions for entering the low-power mode, the battery camera 1 can enter the low-power mode.

An alarm event of the battery camera 1 is triggered by the sensing unit 16. If a target enters the monitored area, the sensing unit 16 triggers an alarm event (for example, when the sensing unit 16 is a PIR alarm, a PIR alarm is triggered), and the encoding chip 12 generates a video for a period before and after the alarm time for the user to view. If there is currently no alarm event, it means that recording and network transmission services after the alarm event do not need to be performed. Correspondingly, there is no need to provide a high-frame-rate video to the user, nor is high-frequency operation of the battery camera 1 required. Therefore, the battery camera 1 can enter the low-power mode.

In this embodiment, the battery camera 1 has an AI model detection function. The AI model detection function refers to using artificial intelligence algorithms, particularly deep learning technology, to analyze and process an image or video stream captured by the battery camera 1 to achieve functions such as target detection, person recognition, face recognition, person re-identification, behavior analysis, vehicle detection and recognition, and abnormal event detection. With the development of hardware technology, an AI chip can be integrated into the battery camera 1 for performing AI model detection in the battery camera 1. In other embodiments, AI model detection can also be performed by connecting to a cloud server. Typically, the battery camera 1 starts performing AI model detection after being powered on and acquires the AI model detection results when an alarm is triggered. If the acquisition of AI model detection results is not currently being performed, it means that there is no need to ensure high-frequency operation of hardware, such as the AI chip used for processing AI model detection, or to provide a high-frame-rate video. Therefore, the battery camera 1 can enter the low-power mode.

When a user with permission to access the battery camera 1 logs into their account via the APP on the electronic device 2 and connects to the battery camera 1, a connection request is sent to the battery camera 1. For the battery camera 1, this request can also be called a connection request from an external device, that is, a user is currently logged in. A user login usually requires accessing the current surveillance footage or browsing recorded videos. If there is currently no connection request from an external device, it means that there is no need to provide a high-frame-rate video to the user at this time, nor is it necessary to ensure high-frequency operation of the hardware. Therefore, the battery camera 1 can enter the low-power mode.

S302, if the battery camera 1 meets the conditions for entering the low-power mode, determining whether the current operating mode of the battery camera 1 is the pre-recording mode or the scheduled recording mode.

S303, if the current operating mode is the pre-recording mode, reducing the recording frame rate of the battery camera 1.

S304, if the current operating mode is the scheduled recording mode, determining whether to reduce the recording frame rate based on the current battery level of the battery camera 1. If the current battery level of the battery camera 1 is within a pre-set battery level range, reducing the recording frame rate of the battery camera 1.

S305, reducing the hardware operating frequency of the battery camera 1, and controlling the battery camera 1 to operate in the low-power mode.

In this embodiment, since reducing the hardware operating frequency reduces the operating performance of the battery camera 1, steps S302-S304 are executed first to determine whether to reduce the recording frame rate based on the operating mode, and then step S305 is executed to reduce the hardware operating frequency of the battery camera 1. Reducing the hardware operating frequency after reducing the recording frame rate improves the execution speed. The above sequence is only the sequence of the specific embodiment shown in FIG. 3A. The present application does not limit the execution order of S302-S304 and S305. In other embodiments, S305 can be executed first, followed by S302-S304, or S302-S304 and S305 can be executed simultaneously.

The recording frame rate of the battery camera 1 refers to the number of images captured per second when the battery camera 1 is recording video. A higher frame rate can provide smoother and clearer video, but also occupies more storage space and bandwidth. A lower frame rate may cause the video to appear choppy or blurry, but reduces storage requirements. When the network of the encoding chip is disabled, no alarm event exists, acquisition of AI model detection results is not being performed, and there is no connection request from an external device, there is no need to provide a high-frame-rate video to the user. At this time, the recording frame rate can be reduced, and the battery camera 1 will encode at a lower frame rate.

In a specific operation, the recording frame rate can be reduced to a fixed value (e.g., a pre-set value). The frame rate of the battery camera 1 during normal operation is generally 12 FPS or 15 FPS, so the reduced recording frame rate can be 1 FPS, 2 FPS, 5 FPS, or 10 FPS, etc. The frame rate value for operating in the low-power mode can be configured by the user through the pre-recording mode configuration interface and the scheduled recording mode configuration interface. The reduced frame rate value can also be determined based on the current battery level of the battery camera 1. For example, if the current battery level is greater than a first threshold, the recording frame rate is reduced to a first value; if the current battery level is lower than or equal to the first threshold, the recording frame rate is reduced to a second value, where the first value is greater than the second value. The first value and the second value can be fixed values, or they can be dynamic values calculated according to a pre-set formula based on the current battery level, which is equivalent to adjusting the recording frame rate in a graded manner based on the current battery level.

By reducing the recording frame rate, the battery camera 1 is caused to operate in the low-power mode, which can reduce the power consumption of the encoding chip 12 and, correspondingly, the overall power consumption of the battery camera 1.

The reduced hardware operating frequency in S305 is the operating frequency for the frequency-adjustable hardware in the battery camera 1. The battery camera 1 comprises frequency-adjustable hardware, such as a CPU, the memory 13, and the MCU 11, and some hardware for processing media-related services, such as the encoding chip 12, the image acquisition unit 15, and an Image Signal Processor (ISP). The frequency-adjustable hardware can operate at different operating frequencies. Operating at a high frequency provides faster processing speeds and higher performance, which is suitable for scenarios requiring high frame rates, high resolutions, and complex image processing, but this also increases the corresponding power consumption and heat generation, and may increase costs. In contrast, operating at a low frequency, although reducing processing speed, can reduce energy consumption and heat generation, extend hardware life, and lower costs, making it suitable for application environments that do not have high real-time requirements and focus on energy saving and stability. When the network of the encoding chip 12 is disabled, no alarm event exists, AI model detection results are not being acquired, and there are no connection requests from external devices, high-frequency hardware operation is not required. At this time, the operating frequency of the aforementioned frequency-adjustable hardware can be reduced to make it operate at a lower frequency.

Specifically, the hardware operating frequency of the battery camera 1 can be reduced to a fixed value (for example, a pre-set value). For example, the DDR frequency can be reduced from 933 MHz to 400 MHz, and the CPU frequency can be reduced from 800 MHz to 400 MHz. The reduced frequency value can also be determined based on the current battery level of the battery camera 1. For example, if the current battery level is greater than a second threshold, the hardware operating frequency is reduced to a third value; if the current battery level is lower than or equal to the second threshold, the hardware operating frequency is reduced to a fourth value, where the third value is greater than the fourth value. The third value and the fourth value can be fixed values, or they can be dynamic values calculated according to a pre-set formula based on the current battery level, which is equivalent to a graded adjustment of the hardware operating frequency based on the current battery level. The second threshold can be the same as or different from the aforementioned first threshold. The operating frequencies of different hardware components can be reduced to different frequency values to meet the actual operating requirements of each component.

By reducing the hardware operating frequency of the battery camera 1, the hardware power consumption can be reduced, and correspondingly, the power consumption of the battery camera 1 is reduced.

Through the operations of S302-S305, the recording frame rate of the battery camera 1 is reduced, and the hardware operating frequency is reduced, thereby causing the battery camera 1 to enter the low-power mode.

In addition, after it is determined that the battery camera 1 meets the conditions for entering the low-power mode, the Artificial Intelligence (AI) model detection can also be stopped. Stopping the AI model detection can also reduce the power consumption of the battery camera, and works in conjunction with the operations of steps S302-S305 to cause the battery camera to enter the low-power mode. Furthermore, since the battery camera 1 is not triggered to alarm merely by the AI model detecting a target object, and only the PIR alarm of the battery camera 1 can trigger an alarm, stopping AI model detection after it is determined that the battery camera 1 meets the conditions for entering the low-power mode does not affect normal alarm services.

FIG. 3B shows a schematic flowchart of a method for controlling a battery camera to exit a low-power mode, provided by an embodiment of the present application. The method is applied in the battery camera 1. As shown in FIG. 3B, the method comprises the following steps:

S306, in response to the battery camera 1 detecting an alarm event or receiving a connection request from an external device, the hardware operating frequency of the battery camera 1 is restored to the operating frequency prior to entering the low-power mode.

S307, in response to the battery camera 1 detecting an alarm event or receiving a connection request from an external device, the recording frame rate of the battery camera 1 is restored to the recording frame rate prior to entering the low-power mode.

In this embodiment, step S306 is executed after step S305 shown in FIG. 3A. When the battery camera 1 is operating in the pre-recording mode or the scheduled recording mode and is in the low-power mode, if an alarm event is detected or a connection request from an external device is received, it indicates that a recorded video needs to be provided for the user to view. At this time, the battery camera 1 needs to restore its recording frame rate and hardware operating frequency to normal values to meet the current scenario requirements.

As described above, step S306 is used to restore the hardware operating frequency, and step S307 is used to restore the recording frame rate. Since restoring the hardware operating frequency can improve the operating performance of the battery camera, step S306 is executed first to restore the hardware operating frequency, and then step S307 is executed to restore the recording frame rate, thereby improving the execution speed. The foregoing sequence is merely the sequence of the specific embodiment shown in FIG. 3B. The present application does not limit the execution order of steps S306 and S307. Step S307 can also be executed first, followed by step S306, or steps S306 and S307 can be executed simultaneously.

Through the operations of S306-S307, the battery camera 1 is caused to exit the low-power mode. In addition, when an alarm event is detected or a connection request from an external device is received, the AI model detection function of the battery camera 1 can also be restored, which, in conjunction with the operations of steps S306 and S307, causes the battery camera 1 to exit the low-power mode.

In an embodiment of the present application, when the battery camera 1 is in the pre-recording mode or the scheduled recording mode, it is determined whether the battery camera 1 meets the conditions for entering the low-power mode. If the conditions are met, the recording frame rate and hardware operating frequency of the battery camera 1 are reduced to cause the battery camera 1 to enter the low-power mode. This allows the battery camera 1 to operate in the pre-recording mode or the scheduled recording mode while reducing its power consumption, thereby increasing its battery level.

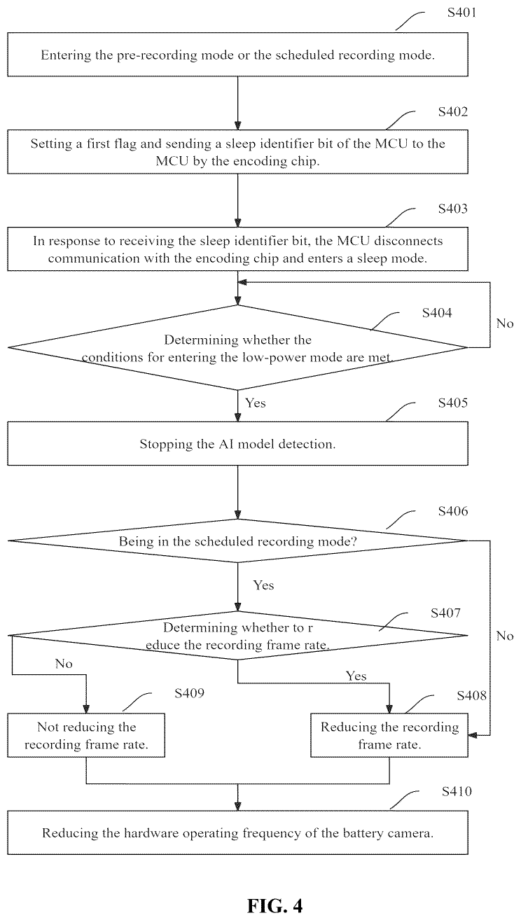

FIG. 4 shows a detailed schematic flowchart of a method for controlling a battery camera to enter a low-power mode, provided by an embodiment of the present application. The method is applied in the battery camera 1 and can be jointly executed by the MCU 11 and the encoding chip 12 in the battery camera 1. As shown in FIG. 4, the method comprises the following steps: S401, entering the pre-recording mode or the scheduled recording mode.

The battery camera 1 is configured with a pre-recording mode and/or a scheduled recording mode, and the Flash of the encoding chip 12 stores the recording frame rate configurations for operation in the two modes. In this embodiment, the low-power mode is a state within the pre-recording mode or the scheduled recording mode, and a prerequisite for entering the low-power mode is that the battery camera 1 is in the pre-recording mode or the scheduled recording mode.

S402, when the network of the encoding chip 12 is disabled, setting a first flag and sending a sleep identifier bit of the MCU 11 to the MCU 11 by the encoding chip 12.

As previously described, after the battery camera 1 is powered on, if no services require the network, the network of the encoding chip 12 is placed in a disabled state. When the Route process (routing process) of the encoding chip 12 detects that the network of the encoding chip 12 is disabled, the encoding chip 12 sets a first flag and stores it in the shared memory of the encoding chip 12. The presence of the first flag can be used as one of the conditions for determining whether to enter the low-power mode. For example, the encoding chip 12 sets the first flag, lowpower_mode, to 1.

When the network of the encoding chip 12 is disabled, the encoding chip 12 also sends the sleep identifier bit of the MCU 11 to the MCU 11. The sleep identifier bit is used to cause the MCU 11 to disconnect communication with the encoding chip and enter the sleep mode. For example, the sleep identifier bit is the busy bit of MCU_SLEEP, and the Route process of the encoding chip 12 sends the busy bit of MCU_SLEEP to the MCU 11.

S403, in response to receiving the sleep identifier bit, disconnecting the communication with the encoding chip by the MCU 11 and enters the sleep mode.

When the MCU 11 receives the busy bit of MCU_SLEEP, it disconnects communication with the encoding chip 12 and enters the sleep mode, which ensures that the MCU 11 reduces interference and effectively conserves energy.

S404, determining whether the first flag is present, whether the network of the encoding chip 12 is disabled, whether no alarm event exists, whether AI model detection results are not being acquired, and whether there are no connection requests from an external device; if yes, S405 is executed; if no, S404 is continued.

When the conditions for entering the low-power mode are met, the battery camera 1 can enter the low-power mode. The ENC process (encoding process) of the encoding chip 12 obtains the lowpower_mode flag from the shared memory. If the network of the encoding chip 12 is disabled, no alarm event exists, AI model detection results are not being acquired, and there are no connection requests from an external device, this indicates that the battery camera 1 meets the conditions for entering the low-power mode, and it begins to enter the low-power mode.

S405, stopping the AI model detection.

After it is determined that the low-power mode needs to be entered, the encoding chip 12 can control an AI model chip of the battery camera 1 to stop performing AI model detection.

S406, it is determined whether the battery camera 1 is in the scheduled recording mode; if yes, S407 is executed; if no, S408 is executed. This step can be performed by the encoding chip 12 to determine whether the camera is in the scheduled recording mode.

S407, it is determined whether to reduce the recording frame rate based on the current battery level; if yes, S408 is executed; if no, S409 is executed. This step can be performed by the encoding chip 12 to determine whether to reduce the recording frame rate based on the current battery level.

S408, reducing the recording frame rate. In this embodiment, the recording frame rate is reduced by the encoding chip 12.

S409, not reducing the recording frame rate. In this embodiment, the encoding chip 12 can maintain the original recording frame rate; that is, the recording frame rate is not reduced.

In S406-S409, it is first determined, based on the current operating mode of the battery camera 1, whether to reduce the recording frame rate directly. If the battery camera 1 is currently in the pre-recording mode, the recording frame rate is directly reduced. If the battery camera 1 is currently in the scheduled recording mode, it is determined whether to reduce the recording frame rate based on the current battery level of the battery camera 1.

In this embodiment, in the configuration of the scheduled recording mode of the battery camera 1, the user can further configure a smart power-saving mode in the configuration interface of the scheduled recording mode APP on the electronic device 2. The user can use this interface to set the enabling/disabling of the smart power-saving mode and related parameters, such as a low frame rate, a low battery level threshold S₁ (first battery level threshold S₁, for example, 2%<S₁≤20%), and a high battery level threshold S₂ (second battery level threshold S₂, for example, 20%<S₂≤100%), where the second battery level threshold S₂ is greater than the first battery level threshold S₁. The low battery level threshold S₁ can be set to a 20% battery level, and the user can also set other values according to actual needs.

When the smart power-saving mode of the battery camera 1 is enabled, if the current battery level of the battery camera 1 is lower than or equal to the low battery level threshold S₁, scheduled recording is disabled, and the battery camera 1 enters a normal standby alarm wakeup state. When the current battery level of the battery camera 1 is greater than the low battery level threshold S₁, the battery camera 1 can enter the scheduled recording mode. Therein, when the current battery level of the battery camera 1 is between the low battery level threshold S₁ and the high battery level threshold S₂, the battery camera 1 records at the aforementioned low frame rate. When the current battery level of the battery camera 1 is greater than the high battery level threshold S₂, the battery camera 1 records at a pre-set full frame rate.

When the smart power-saving mode of the battery camera 1 is disabled, if the current battery level is lower than or equal to a cut-off recording battery level S₀, scheduled recording is disabled, and the battery camera 1 enters a normal standby alarm wakeup state. When the current battery level is greater than the cut-off recording battery level S₀ (for example, the cut-off recording battery level S₀ is pre-set to a 2% battery level), the battery camera 1 enters the scheduled recording mode but does not further change the recording frame rate.

It should be noted that the low battery level threshold S₁ (for when the smart power-saving mode is enabled) and the cut-off recording battery level S₀ (for when the smart power-saving mode is disabled) are the aforementioned battery level for stopping scheduled recording.

Therefore, if the battery camera 1 is currently in the scheduled recording mode, it is further determined whether the smart power-saving mode is enabled to determine whether to reduce the recording frame rate.

If the smart power-saving mode of the battery camera 1 is not enabled, the recording frame rate is not reduced. If the smart power-saving mode of the battery camera 1 is enabled, it is determined whether the current battery level is between the low battery level threshold S₁ and the high battery level threshold S₂. If yes, the recording frame rate is reduced; if no, the recording frame rate is not reduced, and recording is performed at a pre-set full frame rate (that is, the pre-set maximum recording frame rate, for example, 12 FPS or 15 FPS). The current battery level being between the low battery level threshold S₁ and the high battery level threshold S₂ means that the current battery level is in the range (S₁, S₂]. Therefore, in the scheduled recording mode, the recording frame rate is reduced only if the smart power-saving mode is enabled and the current battery level is between the low battery level threshold S₁ and the high battery level threshold S₂; otherwise, the recording frame rate is not reduced. The range between the low battery level threshold S₁ and the high battery level threshold S₂ corresponds to the battery level threshold range in the embodiment shown in FIG. 3A.

S410, reducing the hardware operating frequency of the battery camera 1.

In this embodiment, this step can be executed by the encoding chip 12. After step S408 or step S409, the hardware operating frequency of the battery camera 1 is reduced.

After the battery camera 1 stops AI model detection and its recording frame rate and hardware operating frequency are reduced, it continues to operate in the low-power mode.

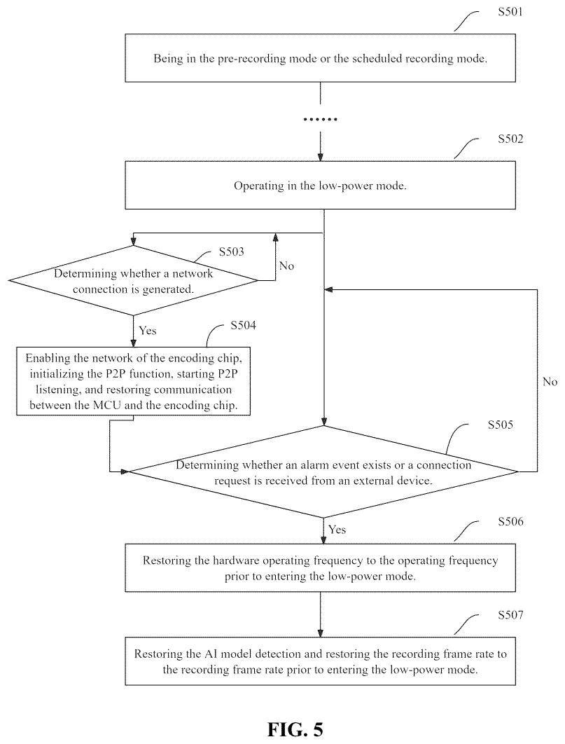

FIG. 5 shows a detailed schematic flowchart of a method for controlling a battery camera to exit a low-power mode, provided by an embodiment of the present application. The method is applied in the battery camera 1 and can be jointly executed by the MCU 11 and the encoding chip 12 in the battery camera 1. As shown in FIG. 5, the method comprises the following steps:

S501, being in the pre-recording mode or the scheduled recording mode. In this embodiment, the battery camera 1 operates in the pre-recording mode or the scheduled recording mode.

S502, operating in the low-power mode. In this embodiment, the operation for the battery camera 1 to exit the low-power mode is executed when the battery camera 1 is in the pre-recording mode or the scheduled recording mode and is already operating in the low-power mode.

S503, determining whether a network connection is generated. If yes, step S504 is executed; if no, step S503 is continued. In this step, the NTS process (a process for handling network connections) of the encoding chip 12 queries the network chip of the battery camera 1 to determine if a network connection exists.

S504, enabling the network of the encoding chip 12, initializing the peer-to-peer (P2P) function, starting P2P listening, and restoring communication between the MCU 11 and the encoding chip 12. Specifically, the network of the encoding chip 12 can be enabled, the P2P function of the battery camera 1 can be initialized, and the P2P listening of the battery camera 1 can be enabled by the MCU process of the encoding chip 12. The communication between the MCU 11 and the encoding chip 12 is restored by the MCU 11.

S505, determining whether an alarm event exists or a connection request is received from an external device. If yes, step S506 is executed; if no, step S505 is continued. This step can be executed by the encoding chip 12.

S506, restoring the hardware operating frequency to the operating frequency prior to entering the low-power mode.

S507, restoring the AI model detection and restoring the recording frame rate to the recording frame rate prior to entering the low-power mode. If step S409 is executed after step S407 in the embodiment shown in FIG. 4, that is, the recording frame rate is not reduced, then the recording frame rate does not need to be changed in this step.

Both steps S506 and S507 can be executed by the encoding chip 12. At this point, the battery camera 1 completes the operation of exiting the low-power mode.

An embodiment of the present application also provides a computer-readable storage medium storing executable instructions, wherein the executable instructions, when executed on a battery camera, cause the battery camera to perform the low-power mode control method for a battery camera according to any of the foregoing method embodiments.

An embodiment of the present application also provides a computer program, which can be called by a processor to cause a battery camera to perform the low-power mode control method for a battery camera according to any of the foregoing method embodiments.

An embodiment of the present application also provides a computer program product, which comprises a computer program stored on a computer-readable storage medium. The computer program comprises program instructions that, when executed on a computer, cause the computer to perform the low-power mode control method for a battery camera according to any of the foregoing method embodiments.

It will be understood by those skilled in the art that the units in the device in the embodiments can be adaptively modified and arranged in one or more devices different from this embodiment. The units in the embodiments can be combined into a single unit or divided into multiple sub-units. All features disclosed in this specification (including the accompanying abstract and drawings), and all processes or units of any method or device so disclosed, may be combined in any combination, except for combinations where at least some of such features and/or processes or units are mutually exclusive. Unless explicitly stated otherwise, each feature disclosed in this specification (including the accompanying abstract and drawings) may be replaced by an alternative feature serving the same, equivalent, or similar purpose.

It should be noted that the foregoing embodiments are intended to illustrate the present application, not to limit it, and that those skilled in the art can devise alternative embodiments without departing from the scope. Unless otherwise specified, the steps in the foregoing embodiments are not to be construed as limiting the order of execution.

What is claimed is:

1. A low-power mode control method for a battery camera, comprising:
acquiring a battery level of the battery camera, in a case where the battery camera is operating in a continuous recording mode under a normal-power mode;
comparing the battery level with a first battery level threshold; and
entering an alarm wake-up recording mode from the continuous recording mode, in a case where the battery level is lower than or equal to the first battery level threshold.

2. The method according to claim 1, the method further comprises:
remaining in the continuous-recording mode under the normal-power mode, in a case where the battery level is greater than the first battery level threshold.

3. The method according to claim 2, the method further comprises:
entering a low-power mode from the normal-power mode, in a case where the battery level is greater than the first battery level threshold and at least one of the following conditions is satisfied:
a network of the battery camera is disabled;
no alarm event exists for the battery camera;
no Artificial Intelligence model for object detection is running in the battery camera; and
no connection request is received from an external device to the battery camera.

4. The method according to claim 3, wherein the continuous-recording mode comprises a pre-recording mode, the method further comprises:
storing an event video comprising video content recorded both before and/or after an alarm of an event in a case where the battery camera is operating in the pre-recording mode.

5. The method according to claim 4, wherein the video content recorded before the alarm of the event is recorded at a first frame rate, and wherein the video content recorded after the alarm of the event is recorded at a second frame rate, wherein the first frame rate is lower than the second frame rate.

6. The method according to claim 5, wherein the first frame rate is pre-set by a user and the second frame rate is a full frame rate of the battery camera.

7. The method according to claim 3, wherein the continuous-recording mode comprises a scheduled recording mode, the method further comprises:
recording continuously during a user-scheduled time period in a case where the battery camera is operating in the scheduled recording mode.

8. The method according to claim 7, the method further comprises:
comparing the battery level with a second battery level threshold;
recording at a third frame rate, in a case where the battery level is greater than the first battery level threshold and lower than or equal to the second battery level threshold; and
recording at a full frame rate, in a case where the battery level is greater than the second battery level threshold;
wherein the first battery level threshold is lower than the second battery level threshold, wherein the third frame rate is lower than the full frame rate.

9. The method according to claim 3, wherein the entering a low-power mode comprises:
controlling a micro-controller unit and an encoding chip of the battery camera to enter a sleep mode; and
controlling the encoding chip to be set with a low-power mode flag.

10. The method according to claim 9, wherein the entering a low-power mode comprises:
reducing the operating frequency of at least one of the following frequency-adjustable hardware components in the battery camera: the micro-controller unit, the encoding chip, a memory, an image acquisition unit, and an image signal processor.

11. The method according to claim 3, the method further comprises:
quitting the low-power mode in a case where at least one of the following conditions is satisfied:
the alarm event exists for the battery camera; and
the connection request is received from the external device to the battery camera.

12. The method according to claim 11, the method further comprises:
restarting operation of the Artificial Intelligence model for object detection in the battery camera.

13. The method according to claim 1, wherein the first battery level threshold is predetermined by a user.

14. A battery camera, comprising: a memory and a processor;
the memory configured to store a plurality of computer-executable instructions; and
the processor coupled to the memory and configured to execute the computer-executable instructions stored in the memory to cause the battery camera to:
acquire a battery level of the battery camera, in a case where the battery camera is operating in a continuous recording mode under a normal-power mode;
compare the battery level with a first battery level threshold; and
enter an alarm wake-up recording mode from the continuous recording mode, in a case where the battery level is lower than or equal to the first battery level threshold.

15. The battery camera according to claim 14, wherein the processor is configured to execute the computer-executable instructions stored in the memory further to:
remain in the continuous-recording mode under the normal-power mode, in a case where the battery level is greater than the first battery level threshold.

16. The battery camera according to claim 15, wherein the processor is configured to execute the computer-executable instructions stored in the memory further to enter a low-power mode from the normal-power mode, in a case where the battery level is greater than the first battery level threshold and at least one of the following conditions is satisfied:
a network of the battery camera is disabled;
no alarm event exists for the battery camera;
no Artificial Intelligence model for object detection is running in the battery camera; and
no connection request is received from an external device to the battery camera.

17. The battery camera according to claim 16, wherein the continuous-recording mode comprises a pre-recording mode, wherein the processor is configured to execute the computer-executable instructions stored in the memory further to:
store an event video comprising video content recorded both before and/or after an alarm of an event in a case where the battery camera is operating in the pre-recording mode.

18. A non-transitory computer-readable storage medium storing a plurality of computer-executable instructions, when executed by one or more processors, cause the one or more processors to:
acquire a battery level of the battery camera, in a case where the battery camera is operating in a continuous recording mode under a normal-power mode;
compare the battery level with a first battery level threshold; and
enter an alarm wake-up recording mode from the continuous recording mode, in a case where the battery level is lower than or equal to the first battery level threshold.

19. The non-transitory computer-readable storage medium according to claim 18, wherein the one or more processors are further caused to:
remain in the continuous-recording mode under the normal-power mode, in a case where the battery level is greater than the first battery level threshold.

20. The non-transitory computer-readable storage medium according to claim 19, wherein the one or more processors are further caused to enter a low-power mode from the normal-power mode, in a case where the battery level is greater than the first battery level threshold and at least one of the following conditions is satisfied:
a network of the battery camera is disabled;
no alarm event exists for the battery camera;
no Artificial Intelligence model for object detection is running in the battery camera; and
no connection request is received from an external device to the battery camera.
